(19) United States
(12) Patent Application Publication
(10) Pub. No.: US 2022/0004989 A1
(43) Pub. Date: Jan. 6, 2022

(54) INFORMATION PROCESSING METHOD AND INFORMATION PROCESSING SYSTEM

(71) Applicant: Panasonic Intellectual Property Management Co., Ltd., Osaka (JP)

(72) Inventors: Hirokazu KAWAMOTO, Osaka (JP); Hiroaki URABE, Osaka (JP)

(21) Appl. No.: 17/481,789

(22) Filed: Sep. 22, 2021

Related U.S. Application Data
(63) Continuation of application No. PCT/JP2020/042083, filed on Nov. 11, 2020.

(30) Foreign Application Priority Data
Nov. 28, 2019 (JP) 2019-215043

(51) Int. Cl. G06Q 10/08

(52) U.S. Cl. CPC G06Q 10/08355; G07C 9/00896; G06Q 10/0838

(57) ABSTRACT

An information processing method is implemented by a computer and includes: obtaining a travel history of a traveling object; detecting, from the travel history, two points between which the traveling object regularly travels; obtaining the location of the origin of a delivery and the location of the destination of the delivery; creating a delivery route of the delivery according to the location of the origin, the location of the destination, and the two points; and outputting the delivery route.

### CROSS REFERENCE TO RELATED APPLICATIONS

This is a continuation application of PCT International Application No. PCT/JP2020/042083 filed on Nov. 11, 2020, designating the United States of America, which is based on and claims priority of Japanese Patent Application No. 2019-215043 filed on Nov. 28, 2019. The entire disclosures of the above-identified applications, including the specifications, drawings and claims are incorporated herein by reference in their entirety.

### FIELD

The present disclosure relates to an information processing method and an information processing system for creating a delivery route of a delivery.

### BACKGROUND

The development of EC, or electronic commerce, in recent years has been leading to a higher volume of deliveries handled by the logistics industry. To respond to the increase in the volume of deliveries, performing delivery tasks more efficiently is encouraged. For instance, a physical distribution method has been disclosed that can increase efficiency in delivery tasks by combining a fixed route, which is a basic route and is traveled by a delivery vehicle, and a variable route to create a delivery route for the delivery vehicle (see e.g., Japanese Unexamined Patent Application Publication No. 2003-300625).

### CITATION LIST

### Patent Literature

PTL 1: Japanese Unexamined Patent Application Publication No. 2003-300625

### SUMMARY

### Technical Problem

However, the physical distribution method disclosed in Japanese Unexamined Patent Application Publication No. 2003-300625 is based on the premise of using a prepared delivery vehicle for delivering deliveries.

The present disclosure, on the other hand, provides an information processing method and an information processing system in which a non-delivery vehicle can be used for the purpose of delivery.

### Solution to Problem

An information processing method according to the present disclosure is implemented by a computer and includes: obtaining a travel history of a traveling object; detecting, from the travel history, two points between which the traveling object regularly travels; obtaining the location of the origin of a delivery and the location of the destination of the delivery; creating a delivery route of the delivery according to the location of the origin, the location of the destination, and the two points; and outputting the delivery route.

It should be noted that these general and specific aspects may be embodied as a system, a method, an integrated circuit, a computer program, or a computer-readable recording medium, such as a CD-ROM, or any combination of the system, method, integrated circuit, computer program, and recording medium.

### Advantageous Effects

In an information processing method and an information processing system according to one or more aspects of the present disclosure, a non-delivery vehicle can be used for the purpose of delivery.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 shows that efficiency in delivery tasks can be increased by using an information processing method according to an embodiment.

FIG. 2 is a sequence diagram illustrating an example of the flow of processing performed by an information processing system according to the embodiment, a traveling object, a delivery vehicle, and a delivery information management system.

FIG. 3 is a block diagram illustrating an example of the information processing system according to the embodiment.

FIG. 4 is a flowchart illustrating an example of the information processing method according to the embodiment.

### DESCRIPTION OF EMBODIMENTS

An information processing method according to one aspect of the present disclosure is implemented by a computer and includes: obtaining a travel history of a traveling object; detecting, from the travel history, two points between which the traveling object regularly travels; obtaining the location of the origin of a delivery and the location of the destination of the delivery; creating a delivery route of the delivery according to the location of the origin, the location of the destination, and the two points; and outputting the delivery route.

The traveling object that travels, for example, to go to work, to go to school, to attend a hospital, or to go shopping, regularly travels between two points, such as a home and a workplace, a home and a school, a home and a hospital, or a home and a store. In the present disclosure, two points between which the traveling object regularly travels are detected from such a travel history of the traveling object. If the two points are located between the origin and destination of a delivery, a delivery route to deliver the delivery from the origin to the destination via the two points is created. That is, a vehicle used for a purpose other than the purpose of delivery (hereinafter, also referred to as a non-delivery vehicle) can be used for delivery. Moreover, whether the non-delivery vehicle is suitable for a delivery vehicle is automatically determined. Thus, a user does not have to preregister the non-delivery vehicle as a delivery vehicle. In the logistics industry, from a management perspective, it is desired that efficiency in delivery tasks be increased while suppressing capital investment. Specifically, it is desired that the delivery capacity be maintained or increased while suppressing the number of delivery vehicles a delivery company holds. In the above information processing method, the traveling object that regularly travels between the two points is used to carry the delivery between the two points instead of a delivery company, which enables the delivery company to increase the delivery capacity while suppressing the number of delivery vehicles they hold. Since the use of the delivery vehicles can be also suppressed, it is possible to reduce the working hours of the drivers of the delivery company. In this manner, efficiency in delivery tasks can be increased while suppressing capital investment.

The traveling object may travel for a purpose other than to deliver the delivery.

By having the traveling object, which travels for a purpose other than to deliver a delivery, carry the delivery instead of a delivery vehicle, it is possible to suppress the number of delivery vehicles the delivery company holds.

One of the two points may be within a predetermined distance from the location of the origin, and the other may be within a predetermined distance from the location of the destination.

This enables the traveling object that regularly travels between the two points to cover a longer distance when carrying the delivery instead of the delivery company on the delivery route. In other words, it is possible to shorten the distance that a delivery vehicle of the delivery company travels to carry the delivery on the delivery route. Accordingly, it is possible to increase efficiency in the delivery tasks of the delivery company.

One of the two points may be within an area covered by delivery services provided by a delivery base which is the origin, and the other may be within an area covered by delivery services provided by another delivery base.

Thus, by having delivery vehicles travel from the respective delivery bases to the two points, it is possible to carry the delivery to the traveling object that regularly travels between the two points and collect the delivery that the traveling object carried between the two points instead of the delivery company.

At each of the two points, the traveling object may stay (a) longer than at any other point on a travel route including the two points or (b) for at least a predetermined period of time, the travel route being detected from the travel history and regularly traveled by the traveling object.

Thus, the traveling object that regularly travels between the two points stays for a long time at the two points. This makes it easier to put the delivery in the traveling object and collect, from the traveling object, the delivery that the traveling object carried between the two points instead of the delivery company, while the traveling object stays at the two points.

The two points may be both endpoints of a travel route including the two points, the travel route being detected from the travel history and regularly traveled by the traveling object.

If the two points are both endpoints of the travel route regularly traveled by the traveling object, the traveling object that regularly travels between the two points can cover a longer distance when carrying the delivery instead of the delivery company on the delivery route.

A travel-start time slot or a travel-finish time slot of the traveling object at each of the two points may be detected from the travel history. A delivery time at which the delivery is expected to arrive at the destination may be obtained. The creating of the delivery route may include creating the delivery route further according to the delivery time and the travel-start time slot or the travel-finish time slot of the traveling object at each of the two points.

Thus, it is possible to create the delivery route that enables the following plan: the delivery is to be put in the traveling object before the traveling object starts traveling, collected from the traveling object after the traveling object has finished traveling and before the delivery time, and delivered to the destination at the delivery time. In addition, since the delivery is in the traveling object while the traveling object stays at the two points, the traveling object serves as a temporary warehouse for the delivery during the stay at the two points. Accordingly, it is possible to cut the time that the warehouse of the delivery company stores the delivery, which can save the space of the warehouse of the delivery company.

The degree of reliability for a travel regularity of the traveling object between the two points may be calculated according to the travel history. The detecting of the two points may include detecting the two points further according to the degree of reliability.

Thus, it is possible to detect two points with regard to a traveling object having a high degree of reliability for its travel regularity. That is, the two points detected on the basis of the degrees of reliability are two points between which the traveling object will more reliably travel in accordance with the travel regularity during delivery of the delivery. This can suppress the occurrence of trouble in delivery of the delivery that may be caused if the traveling object does not travel between the two points in accordance with the travel regularity during delivery of the delivery.

The administrator of the traveling object may be queried about the travel schedule of the traveling object during delivery of the delivery. The creating of the delivery route may include creating the delivery route further according to a reply to the query.

If the received reply says that the traveling object is going to travel in accordance with the travel regularity during delivery of the delivery, the traveling object will more reliably travel between the two points during delivery of the delivery. Meanwhile, if the received reply says that the traveling object is not going to travel in accordance with the travel regularity during delivery of the delivery, it is possible to avoid using the traveling object for delivery. This can suppress the occurrence of trouble in delivery of the delivery that may be caused if the traveling object does not travel between the two points in accordance with the travel regularity during delivery of the delivery.

After completion of delivery of the delivery based on the delivery route, a benefit may be offered to the administrator of the traveling object.

By offering a benefit to the administrator of the traveling object that carried the delivery between the two points instead of the delivery company, future active involvement of the traveling object in carrying a delivery instead of the delivery company can be expected. This can further increase efficiency in delivery tasks.

The administrator of the traveling object may be notified that the delivery is to be or has been put in or collected from the traveling object at each of the two points.

This allows the administrator of the traveling object to know that the delivery is to be put in the traveling object, that the delivery was put in the traveling object, that the delivery is to be collected from the traveling object, or that the delivery was collected from the traveling object.

The traveling object may be requested to unlock the trunk or a door of the traveling object at the two points.

This enables the traveling object to unlock the trunk or a door of the traveling object when the delivery is put in or collected from the trunk, front passenger seat, or back seats of the traveling object, which can save the administrator of the traveling object and the delivery company the trouble.

An information processing system according to another aspect of the present disclosure includes: a travel history obtainment unit that obtains a travel history of a traveling object; a detector that detects, from the travel history, two points between which the traveling object regularly travels; a delivery information obtainment unit that obtains the location of the origin of a delivery and the location of the destination of the delivery; a creator that creates a delivery route of the delivery according to the location of the origin, the location of the destination, and the two points; and an output unit that outputs the delivery route.

Thus, it is possible to provide the information processing system in which a non-delivery vehicle can be used for the purpose of delivery.

Hereinafter, embodiments are described in detail with reference to the drawings.

It should be noted that each of the exemplary embodiments described below shows a general or specific example. The numerical values, shapes, materials, structural elements, the arrangement and connection of the structural elements, steps, the processing order of the steps, and others shown in the following exemplary embodiments are mere examples, and therefore do not limit the present disclosure.

### EMBODIMENT

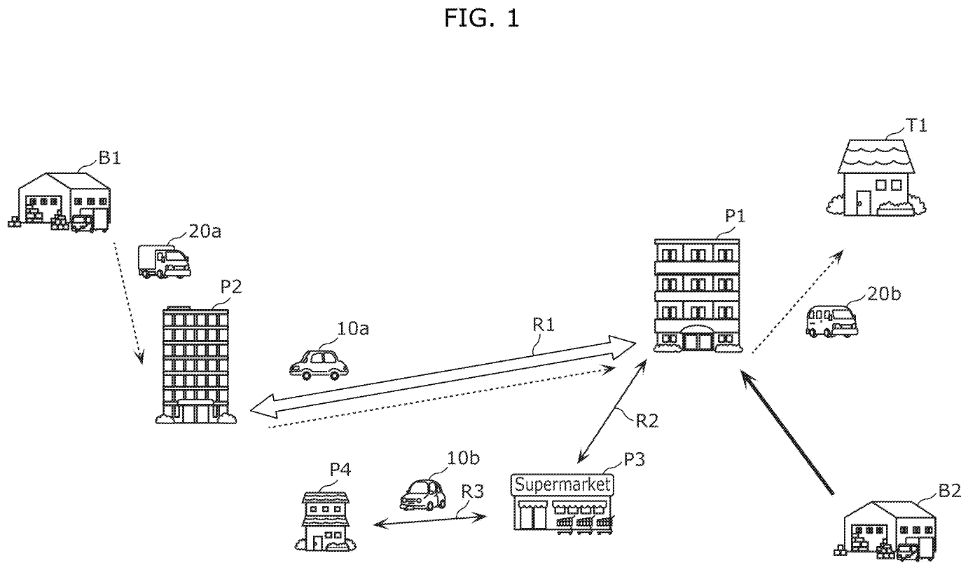

An embodiment is described with reference to FIGS. 1 to 4.

FIG. 1 shows that a non-delivery vehicle can be used for the purpose of delivery by using an information processing method according to an embodiment. The details of the information processing method are described later. First, to be able to use a non-delivery vehicle for the purpose of delivery by using the information processing method in the present disclosure is described with reference to FIG. 1.

Traveling objects 10a and 10b, such as private car or taxi, regularly travel between at least two points for a purpose other than to deliver a delivery. Such traveling objects regularly travel back and forth between at least two points, for instance, to go to work, to go to school, to attend a hospital, or to go shopping. For instance, traveling object 10a has a travel regularity: on work days, traveling object 10a travels between two points, home P1 and company P2, on travel route R1, and on days off, traveling object 10a travels between two points, home P1 and store P3, on travel route R2. Here, home P1 is the home of the administrator of traveling object 10a, and company P2 is the workplace of the administrator of traveling object 10a. As another example, traveling object 10b has a travel regularity: traveling object 10b travels between two points, home P4 and store P3, on travel route R3 every day, home P4 being the home of the administrator of traveling object 10b.

Hereinafter, an example is described in which a delivery at the origin of the delivery (e.g., base B1) is delivered to the destination of the delivery (e.g., home T1) by using the information processing method in the present disclosure.

Delivery vehicle 20a departs from base B1 and carries the delivery to company P2, one of the two points between which traveling object 10a regularly travels. Traveling object 10a, in which the administrator of traveling object 10a drove to work, stays in company P2. While traveling object 10a stays in company P2 (e.g., during the daytime), the delivery is transferred from delivery vehicle 20a to traveling object 10a.

Having finished working at company P2, which the administrator of traveling object 10a works for, the administrator drives home P1 in traveling object 10a. That is, traveling object 10a having the delivery travels from company P2 to home P1.

Then, delivery vehicle 20b travels from base B2 to home P1, the other point of the two points between which traveling object 10a regularly travels. While traveling object 10a stays in home P1 (e.g., during the night), the delivery is collected from traveling object 10a and then delivered to home T1.

Thus, the delivery vehicles of a delivery company do not cover all sections of the delivery route to deliver the delivery from the origin (e.g., base B1) to the destination (e.g., home T1). Instead, regarding a part of the sections, the traveling object that regularly travels the part of the sections carries the delivery instead of the delivery company when regularly traveling the section. This means that a non-delivery vehicle can be used for the purpose of delivery. By using the traveling object, the delivery company can increase the delivery capacity while suppressing the number of delivery vehicles they hold. It should be noted that since the traveling object regularly travels the section regardless of delivery of the delivery, the delivery of the delivery does not place a huge burden on the administrator of the traveling object.

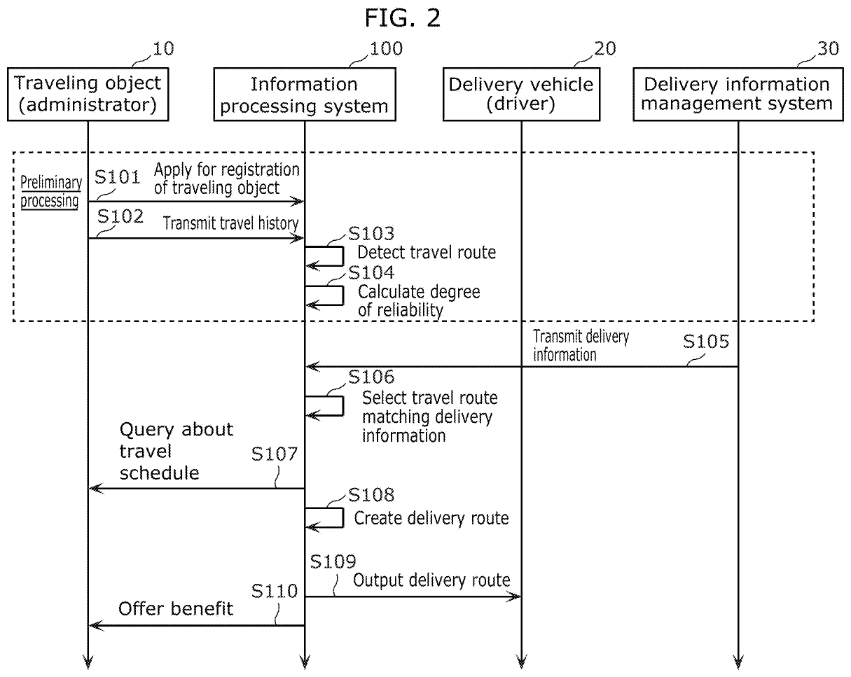

Hereinafter, with reference to FIG. 2, the outline of the flow of processing performed by an information processing system, a traveling object, a delivery vehicle, and a delivery information management system is described. The information processing system creates a delivery route including a section covered by the traveling object that regularly travels between two points. The delivery information management system manages delivery information including, for example, the origin and destination of a delivery and a delivery time.

FIG. 2 is a sequence diagram illustrating an example of the flow of processing performed by information processing system 100 according to the embodiment, traveling object 10, delivery vehicle 20, and delivery information management system 30. It should be noted that traveling object 10 may be considered the administrator of traveling object 10 (specifically, for example, the personal computer (PC) or portable terminal of the administrator). In addition, delivery vehicle 20 may be considered the administrator of delivery vehicle 20 (specifically, for example, the PC or portable terminal of the administrator). It should be noted that the administrator of traveling object 10 may be the driver of traveling object 10. If traveling object 10 is a self-driving vehicle, the administrator of traveling object 10 may be a passenger in traveling object 10 or the administrator who manages traveling object 10 without riding in traveling object 10. Likewise, the administrator of delivery vehicle 20 may be the driver of delivery vehicle 20. If delivery vehicle 20 is a self-driving vehicle, the administrator of delivery vehicle 20 may be a passenger in delivery vehicle 20 or the administrator who manages delivery vehicle 20 without riding in delivery vehicle 20. Hereinafter, the administrator of delivery vehicle 20 is described as the driver of delivery vehicle 20.

The processing in steps S101 to S104 performed prior to creation of a delivery route is described.

The administrator of traveling object 10 makes a registration application to information processing system 100 so that traveling object 10 can be used to carry a delivery instead of the delivery company (step S101). As described later, a benefit is offered to the administrator of traveling object 10 that carried a delivery instead of the delivery company. The benefit, for example, can be an incentive for the administrator of traveling object 10 to apply for the registration of traveling object 10. For instance, the registration of various traveling objects 10 is applied for. When registration is applied for or after traveling object 10 is registered, traveling object 10 or the administrator of traveling object 10 may transmit, to information processing system 100, a travel route regularly traveled by traveling object 10, that the administrator of traveling object 10 is aware of.

Traveling object 10 registered in information processing system 100 transmits a travel history of traveling object 10 to information processing system 100 (step S102). For instance, traveling object 10a travels from home P1 to company P2 on travel route R1 on work day mornings. Traveling object 10a travels from company P2 to home P1 on travel route R1 on work day nights. Traveling object 10a transmits the travel history to information processing system 100.

Information processing system 100 detects a travel route regularly traveled by traveling object 10 from the travel history transmitted from traveling object 10 (step S103). For instance, information processing system 100 detects travel route R1 regularly traveled by traveling object 10a from the travel history transmitted from traveling object 10a. It should be noted that the details of detection of the travel route are described later.

In addition, according to the travel history transmitted from traveling object 10, information processing system 100 calculates the degree of reliability for a travel regularity of traveling object 10 for the travel route regularly traveled by traveling object 10 (step S104). For instance, according to the travel history transmitted from traveling object 10a, information processing system 100 calculates the degree of reliability for a travel regularity of traveling object 10a for travel route R1 regularly traveled by traveling object 10a.

It should be noted that information processing system 100 may detect another travel route (e.g., travel route R2) of traveling object 10a and calculate the degree of reliability for another travel route. Although the above description focuses on traveling object 10a, information processing system 100 also detects the travel routes of other traveling objects 10 (e.g., traveling object 10b) and calculates the degrees of reliability for the travel routes.

Thus, the processing in steps S101 to S104 is performed prior to the creation of the delivery route. It should be noted that even after the processing of creating the delivery route, the travel route and the degree of reliability may be updated through transmission of a travel history, detection of a travel route, and calculation of the degree of reliability.

Delivery information management system 30 transmits delivery information to information processing system 100 (step S105). The delivery information includes, for example, the location of the origin of a delivery and the location of the destination of the delivery. If for instance a delivery has to be delivered from base B1 to home T1, delivery information management system 30 transmits, to information processing system 100, the location of base B1 as the location of the origin and the location of home T1 as the location of the destination.

Information processing system 100 selects a travel route matching the received delivery information from the detected travel routes (various travel routes including, for example, travel routes R1 and R2 of traveling object 10a and travel route R3 of traveling object 10b) (step S106). For instance, information processing system 100 selects a travel route that enables the following: when the delivery is carried from the origin to the destination, delivery vehicle 20 that will carry the delivery travels as short as possible, that is, traveling object 10 that will carry the delivery instead of the delivery company travels as far as possible. For instance, information processing system 100 selects travel route R1 from travel routes R1, R2, and R3. It should be noted that when the travel route is selected, a time slot (time slots) during which traveling object 10 travels the travel route and a delivery time at which the delivery is expected to arrive at the destination may be considered. The details are described later.

Information processing system 100 queries the administrator of traveling object 10 that travels the selected travel route about the travel schedule of traveling object 10 during delivery of the delivery (step S107). Information processing system 100 may receive a reply saying that traveling object 10 is not going to travel the selected travel route during delivery of the delivery. In this case, information processing system 100 reselects a travel route from the detected travel routes other than the initially selected travel route. For instance, information processing system 100 may receive a reply saying that traveling object 10a is not going to travel selected travel route R1 during delivery of the delivery. In this case, information processing system 100 selects a travel route from the travel routes other than travel route R1.

If information processing system 100 receives a reply saying that traveling object 10 is going to travel the selected travel route during delivery of the delivery, information processing system 100 creates a delivery route including the selected travel route (step S108). If for instance information processing system 100 receives a reply saying that traveling object 10a is going to travel selected travel route R1 during delivery of the delivery, information processing system 100 creates a delivery route including travel route R1. Specifically, information processing system 100 creates a delivery route to deliver the delivery from base B1 to home T1 via company P2 and home P1.

Information processing system 100 outputs (specifically, transmits) the created delivery route to the driver of delivery vehicle 20 (step S109). For instance, information processing system 100 transmits the created delivery route to the driver of delivery vehicle 20a and the driver of delivery vehicle 20b.

The driver of delivery vehicle 20a checks the received delivery route, carries the delivery from base B1 to company P2, and puts the delivery in traveling object 10a staying in company P2. Having finished working at company P2, the administrator of traveling object 10a drives home P1 in traveling object 10a. Since the delivery is in traveling object 10a, when the administrator drives home, traveling object 10a carries the delivery to home P1 instead of the delivery company. The driver of delivery vehicle 20b checks the received delivery route, travels from base B2 to home P1, collects the delivery from traveling object 10a staying in home P1, and delivers the collected delivery to home T1.

After completion of delivery of the delivery based on the delivery route, information processing system 100 offers a benefit to the administrator of traveling object 10 (step S110). For instance, a benefit is offered to the administrator of traveling object 10a because the administrator helped the delivery company deliver the delivery when traveling back and forth between home P1 and company P2 as always.

It should be noted that although the travel route regularly traveled by traveling object 10 is used in FIG. 2, two points between which traveling object 10 regularly travels may be used instead of the travel route.

Although delivery is described in the above example, the same accounts may apply to collection of a delivery. For instance, instead of a base, a home is set to the origin of a delivery, and instead of a home, a base is set to the destination of the delivery. Then, the processing described above is performed.

Accordingly, by using the information processing method in the present disclosure, efficiency in delivery tasks can be increased while suppressing capital investment. Hereinafter, the details of the information processing method and information processing system 100 that aim to increase efficiency in delivery tasks while suppressing capital investment are described.

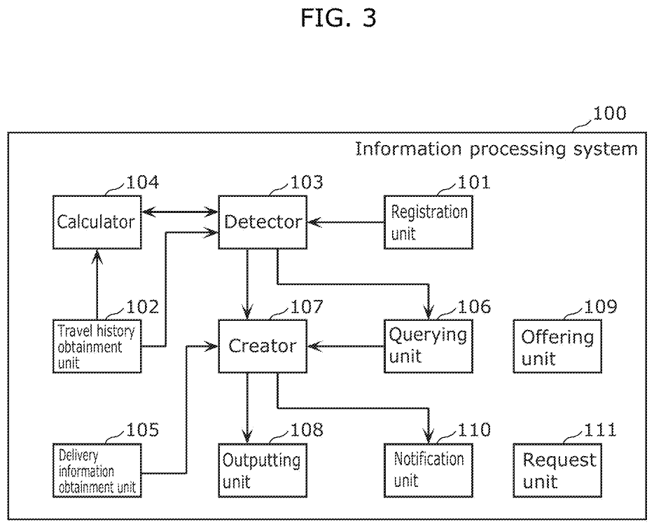

FIG. 3 is a block diagram illustrating an example of information processing system 100 according to the embodiment.

Information processing system 100, such as a server, is a device that creates a delivery route including a section covered by the delivery vehicle and a section covered by the traveling object that regularly travels between two points. Information processing system 100 includes registration unit 101, travel history obtainment unit 102, detector 103, calculator 104, delivery information obtainment unit 105, querying unit 106, creator 107, outputting unit 108, offering unit 109, notification unit 110, and request unit 111. Information processing system 100 is a computer including, for example, a processor, memory, and a communication interface. The memory includes, for example, read only memory (ROM) and random-access memory (RAM) and can store a program to be run by the processor. Registration unit 101, travel history obtainment unit 102, detector 103, calculator 104, delivery information obtainment unit 105, querying unit 106, creator 107, outputting unit 108, offering unit 109, notification unit 110, and request unit 111 are caused to function by the processor or other equipment running the program stored in the memory. It should be noted that the structural elements of information processing system 100 may be distributed among two or more servers.

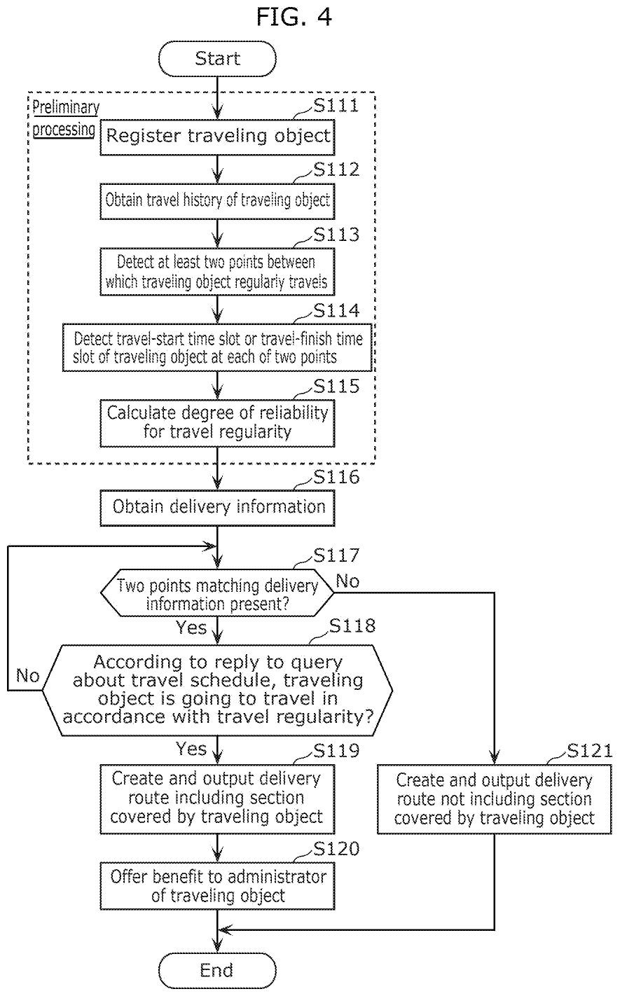

With reference to FIG. 4, the functions of registration unit 101, travel history obtainment unit 102, detector 103, calculator 104, delivery information obtainment unit 105, querying unit 106, creator 107, outputting unit 108, offering unit 109, notification unit 110, and request unit 111, which are caused to function by the processor or other equipment running the program, are described.

FIG. 4 is a flowchart illustrating an example of the information processing method according to the embodiment. For instance, the information processing method according to the embodiment is implemented by the computer (specifically, processor) of information processing system 100. That is, FIG. 4 is a flowchart illustrating operations performed by registration unit 101, travel history obtainment unit 102, detector 103, calculator 104, delivery information obtainment unit 105, querying unit 106, creator 107, outputting unit 108, offering unit 109, notification unit 110, and request unit 111.

The processing in steps S111 to S115 performed prior to the creation of a delivery route is described.

Registration unit 101 registers traveling object 10, the registration of which has been applied for by the administrator of traveling object 10 (step S111). If the administrator of traveling object 10 transmits, to registration unit 101, at least two points between which traveling object 10 regularly travels, that the administrator of traveling object 10 is aware of, registration unit 101 may register the at least two points. In addition, a travel-start time slot or a travel-finish time slot of traveling object 10 at each of two points may be registered. It should be noted that the at least two points may be two points or two or more points or may be construed as a travel route connecting the two or more points to each other.

Travel history obtainment unit 102 obtains a travel history of registered traveling object 10 (step S112). Travel history obtainment unit 102 may obtain the travel history by successively obtaining the current location of traveling object 10 from registered traveling object 10. Alternatively, travel history obtainment unit 102 may obtain, from traveling object 10, the travel history that traveling object 10 calculated from a change from the current location of traveling object 10. Travel history obtainment unit 102 continuously obtains the travel history of traveling object 10.

Detector 103 detects, from the travel history, at least two points between which traveling object 10 regularly travels (step S113). Detector 103 can identify a travel regularity of traveling object 10 from the travel history of traveling object 10 that travel history obtainment unit 102 continuously obtains. Thus, detector 103 can detect at least two points between which traveling object 10 regularly travels. For instance, a travel pattern in which traveling object 10 departs from a particular point and arrives at a particular point is repeated predetermined times. In such a case, at least two points are detected. For instance, for traveling object 10a, detector 103 detects home P1 and company P2 as two points between which traveling object 10a regularly travels. Detector 103 may detect two points between which traveling object 10 regularly travels, on the basis of two points preregistered by the administrator of traveling object 10 in addition to the travel history. Detection also based on the preregistered two points leads to higher accuracy in detection of the two points.

For instance, one of the two points may be within a predetermined distance from the location of the origin, and the other may be within a predetermined distance from the location of the destination. If for instance one of the two points detected by detector 103 is company P2, company P2 may be a point within a predetermined distance from the origin (e.g., base B1). If for instance the other of the two points detected by detector 103 is home P1, home P1 may be a point within a predetermined distance from home T1. This enables traveling object 10 that regularly travels between the two points to cover a longer distance when carrying the delivery instead of the delivery company on the delivery route. In other words, it is possible to shorten the distance that delivery vehicle 20 of the delivery company travels to carry the delivery on the delivery route. Accordingly, it is possible to increase efficiency in the delivery tasks of the delivery company.

For instance, one of the two points may be within an area covered by delivery services provided by a delivery base which is the origin, and the other may be within an area covered by delivery services provided by another delivery base. If one of the two points detected by detector 103 is company P2, company P2 may be within an area covered by delivery services provided by base B1. If the other of two points detected by detector 103 is home P1, home P1 may be within an area covered by delivery services provided by base B2 different from base B1. Thus, by having delivery vehicles 20 travel from the respective delivery bases to the two points, it is possible to carry the delivery to traveling object 10 that regularly travels between the two points and collect the delivery that traveling object 10 carried between the two points instead of the delivery company.

It should be noted that the at least two points may be two points or two or more points or may be construed as a travel route connecting the two or more points to each other. That is, detector 103 may detect a travel route regularly traveled by traveling object 10. For instance, for traveling object 10a, detector 103 detects travel route R1 regularly traveled by traveling object 10a.

For instance, at each of the two points, traveling object 10 may stay (a) longer than at any other point on a travel route including the two points or (b) for at least a predetermined period of time, the travel route being detected from the travel history and regularly traveled by traveling object 10. If the two points detected by detector 103 are home P1 and company P2, at each of home P1 and company P2, traveling object 10a stays longer than at any other point on travel route R1 including home P1 and company P2. Home P1 is the home of the administrator of traveling object 10a, and company P2 is the workplace of the administrator of traveling object 10a. Thus, as a matter of course, traveling object 10a stays longer at home P1 and company P2 than at any other point. Although not limited to a particular period of time, the predetermined period of time is, for example, around several hours. This makes it easier to put the delivery in traveling object 10 and collect, from delivery vehicle 10, the delivery that traveling object 10 carried between the two points instead of the delivery company, while traveling object 10 stays at the two points.

For instance, the two points may be both endpoints of the travel route including the two points, the travel route being detected from the travel history and regularly traveled by traveling object 10. If the two points detected by detector 103 are home P1 and company P2, the locations of home P1 and company P2 are both endpoints of travel route R1. This enables traveling object 10 that regularly travels between the two points to cover a longer distance when carrying the delivery instead of the delivery company on the delivery route.

Detector 103 detects, from the travel history, a travel-start time slot or a travel-finish time slot of traveling object 10 at each of the two points (step S114). For instance, the travel history includes time information, and thus it is possible to detect, from the travel history, when and where traveling object 10 traveled and stayed. Thus, detector 103 can detect when traveling object 10 started traveling at the two points and when traveling object 10 arrived at the two points (that is, when traveling object 10 finished traveling).

For instance, a travel pattern in which during a specific time slot on a specific day of the week, traveling object 10 departs from a particular point and arrives at a particular point is repeated predetermined times. In this case, detector 103 detects a travel-start time slot or a travel-finish time slot of traveling object 10 at each of the two points. For instance, detector 103 detects a travel-start time slot during which traveling object 10a departs from home P1, a travel-finish time slot during which traveling object 10a arrives at company P2, a travel-start time slot during which traveling object 10a departs from company P2, and a travel-finish time slot during which traveling object 10a arrives at home P1. For instance, detector 103 detects that the travel-start time slot during which traveling object 10a departs from home P1 matches 7 a.m. on work days, that the travel-finish time slot during which traveling object 10a arrives at company P2 matches 8 a.m. on work days, that the travel-start time slot during which traveling object 10a departs from company P2 matches 5 p.m. on work days, and that the travel-finish time slot during which traveling object 10a arrives at home P1 matches 6 p.m. on work days.

It should be noted that machine learning may be used for detection by detector 103.

According to the travel history, calculator 104 calculates the degree of reliability for the travel regularity of traveling object 10 between the two points (step S115). For instance, traveling object 10 may not travel between the two points during the particular time slot(s). For instance, traveling object 10a has a travel regularity: on work days, traveling object 10a departs from home P1 at 7 a.m. and arrives at company P2 at 8 a.m. However, traveling object 10a may travel without following the travel regularity a few times a month. In this case, the travel history also includes the history of travel that does not follow the travel regularity. According to such a travel history, calculator 104 calculates, for example, the probability that traveling object 10a travels between home P1 and company P2 in accordance with the travel regularity, as the degree of reliability for the travel regularity of traveling object 10 between home P1 and company P2. For instance, in a month having 20 work days, on two days out of 20 work days, traveling object 10a did not follow the travel regularity: traveling object 10a departs from home P1 at 7 a.m. and arrives at company P2 at 8 a.m. In other words, traveling object 10a traveled in accordance with the travel regularity on 18 days. In this case, calculator 104 determines the degree of reliability for the travel regularity of traveling object 10a between the two points as a 90% (18 days/20 days) probability. It should be noted that detector 103 may detect two points again on the basis of the calculated degree of reliability. For instance, detector 103 may remove, from detected sets of two points, two points having a degree of reliability less than or equal to a predetermined value. Thus, detector 103 can detect two points with regard to traveling object 10 having a high degree of reliability for its travel regularity. That is, the two points detected on the basis of the degrees of reliability are two points between which traveling object 10 will more reliably travel in accordance with the travel regularity during delivery of the delivery. This can suppress the occurrence of trouble in delivery of the delivery that may be caused if traveling object 10 does not travel between the two points in accordance with the travel regularity during delivery of the delivery.

It should be noted that calculator 104 may calculate the degree of reliability for the travel regularity of traveling object 10 not only between the two points but also for the travel route (that is, a collection of multiple points).

In this manner, the processing in steps S111 to S115 is performed prior to the creation of the delivery route. It should be noted that even after the processing of creating the delivery route, the two points, the travel-start time slot or travel-finish time slot of traveling object 10 at each of the two points, or the degree of reliability may be updated through registration of traveling object 10, obtainment of a travel history, detection of two points, detection of a travel-start time slot or a travel-finish time slot of traveling object 10 at each of the two points, and calculation of the degree of reliability.

Delivery information obtainment unit 105 obtains delivery information (step S116). Specifically, as the delivery information, delivery information obtainment unit 105 obtains the locations of the origin and destination of the delivery. In addition, as the delivery information, delivery information obtainment unit 105 may obtain a delivery time at which the delivery is expected to arrive at the destination. For instance, delivery information obtainment unit 105 obtains the location of base B1 as the location of the origin and the location of home T1 as the location of the destination and identifies 7 p.m. to 9 p.m. as a delivery time slot during which the delivery is expected to arrive at the destination.

Detector 103 detects, for each of various traveling objects 10, two points between which traveling object 10 regularly travels. Creator 107 determines whether two points matching the delivery information are present among the detected various sets of two points (step S117). Since for instance company P2 is near base B1, home P1 is near both T1 and base B2, and traveling object 10a is expected to stay in home P1 at the delivery time, creator 107 determines that two points matching the delivery information are present. It should be noted that if two or more sets of two points matching the delivery information are present, two points for which the highest degree of reliability has been calculated by calculator 104 may be selected as two points matching the delivery information. In addition, creator 107 may determine whether two points matching the delivery information are present among sets of two points for which certain degrees of reliability have been calculated by calculator 104.

If it is determined that two points matching the delivery information are present (Yes in step S117), querying unit 106 queries the administrator of traveling object 10 that regularly travels between the two points about the travel schedule of traveling object 10 during delivery of the delivery. Then, according to the reply from the administrator of traveling object 10, querying unit 106 determines whether traveling object 10 is going to travel in accordance with the travel regularity (step S118). For instance, because of a change in the normal schedule of the administrator of traveling object 10, traveling object 10 may not travel between the two points during delivery of the delivery. For this reason, querying unit 106 queries about the travel schedule. It should be noted that if querying unit 106 does not receive a reply to the query, the processing may return to step S117. Alternatively, creator 107 may create a delivery route on the presumption that traveling object 10 is going to travel in accordance with the travel regularity. In the latter case, if it turns out that the schedule of traveling object 10 did not conform to the travel regularity, a delivery person may bring back the delivery as in a case where a recipient is absent at the time of delivery, or creator 107 may arrange an alternative delivery route.

If the reply from the administrator of traveling object 10 to the query says that traveling object 10 is not going to travel in accordance with the travel regularity (No in step S118), the two points detected as the two points matching the delivery information are removed, and then the processing restarts from step S117.

If the reply from the administrator of traveling object 10 to the query says that traveling object 10 is going to travel in accordance with the travel regularity (Yes in step S118), traveling object 10 is expected to travel in accordance with the travel regularity. Thus, creator 107 creates a delivery route including a section covered by traveling object 10, and outputting unit 108 outputs the created delivery route (step S119). For instance, creator 107 creates a delivery route that enables the following plan. The delivery is to be carried from base B1 to company P2 and put in traveling object 10a between 8 a.m. and 5 p.m. on a work day. The delivery is to be collected from traveling object 10a staying in home P1 after 6 p.m. on the work day. The delivery is to be delivered to home T1 between 7 p.m. and 9 p.m. Then, outputting unit 108 outputs the created delivery route to delivery vehicles 20a and 20b.

Thus, creator 107 creates the delivery route of the delivery according to the location of the origin, the location of the destination, and the two points between which traveling object 10 regularly travels. At that time, creator 107 may create the delivery route also based on the travel-start time slot or travel-finish time slot of traveling object 10 at each of the two points and the delivery time at which the delivery is expected to arrive at the destination. Thus, it is possible to create the delivery route that enables the following plan: the delivery is to be put in traveling object 10 before traveling object 10 starts traveling, collected from traveling object 10 after traveling object 10 has finished traveling and before the delivery time, and delivered to the destination at the delivery time. In addition, since the delivery is in traveling object 10 while traveling object 10 stays at the two points, traveling object 10 serves as a temporary warehouse for the delivery during the stay at the two points. Accordingly, it is possible to cut the time that the warehouse of the delivery company stores the delivery, which can save the space of the warehouse of the delivery company.

In addition, creator 107 may create the delivery route according to the reply to the query about the travel schedule of traveling object 10 during delivery of the delivery. If the received reply says that traveling object 10 is going to travel in accordance with the travel regularity during delivery of the delivery, traveling object 10 will more reliably travel between the two points during delivery of the delivery. Meanwhile, if the received reply says that traveling object 10 is not going to travel in accordance with the travel regularity during delivery of the delivery, it is possible to avoid using traveling object 10 for delivery. This can suppress the occurrence of trouble in delivery of the delivery that may be caused if traveling object 10 does not travel between the two points in accordance with the travel regularity during delivery of the delivery.

After completion of delivery of the delivery based on the output delivery route, offering unit 109 offers a benefit to the administrator of traveling object 10 (step S120). The benefit is, for example, money, a cash voucher, or points that can be used for purchasing goods or services. By offering a benefit to the administrator of traveling object 10 that carried the delivery between the two points instead of the delivery company, future active involvement of traveling object 10 in carrying a delivery instead of the delivery company can be expected. This can further increase efficiency in delivery tasks.

If it is determined that no two points matching the delivery information are present (No in step S117), creator 107 creates a delivery route not including a section covered by traveling object 10, and outputting unit 108 outputs the created delivery route (step S121). For instance, creator 107 creates a delivery route to directly deliver the delivery from base B1 to home T1, and outputting unit 108 outputs the created delivery route to delivery vehicle 20a.

The administrator of traveling object 10 may get suspicious if the delivery is put in traveling object 10 without notice. Thus, for instance, notification unit 110 notifies the administrator of traveling object 10 that the delivery is to be or has been put in or collected from traveling object 10 at each of the two points. It should be noted that before the delivery is put in traveling object 10, notification unit 110 may notify the administrator of traveling object 10 that the delivery is to be put in traveling object 10, or after the delivery is put in traveling object 10, notification unit 110 may notify the administrator of traveling object 10 that the delivery was put in traveling object 10. In addition, before the delivery is collected from traveling object 10, notification unit 110 may notify the administrator of traveling object 10 that the delivery is to be collected from traveling object 10, or after the delivery is collected from traveling object 10, notification unit 110 may notify the administrator of traveling object 10 that the delivery was collected from traveling object 10. This allows the administrator of traveling object 10 to know that the delivery is to be put in traveling object 10, that the delivery was put in traveling object 10, that the delivery is to be collected from traveling object 10, or that the delivery was collected from traveling object 10.

When the delivery is put in or collected from the trunk, front passenger seat, or back seats of traveling object 10, the trunk or a door of traveling object 10 has to be unlocked. Thus, request unit 111 requests traveling object 10 to unlock the trunk or a door of traveling object 10 at the two points. For instance, request unit 111 receives an instruction to unlock the trunk or a door of traveling object 10 from the driver of delivery vehicle 20. In response to the instruction, request unit 111 requests traveling object 10 to unlock the trunk or door of traveling object 10. This enables traveling object 10 to unlock the trunk or door of traveling object 10 when the delivery is put in or collected from the trunk, front passenger seat, or back seats of traveling object 10, which can save the administrator of traveling object 10 and the delivery company the trouble.

As described above, if two points between which traveling object 10 regularly travels are detected, and the two points are located between the origin and destination of a delivery, a delivery route to deliver the delivery from the origin to the destination via the two points is created. Thus, traveling object 10 (i.e., vehicle used for a purpose other than the purpose of delivery) can be used for delivery. Moreover, whether traveling object 10 is suitable for a delivery vehicle is automatically determined, a user does not have to preregister traveling object 10 as a delivery vehicle. In addition, regarding the two points between which traveling object 10 regularly travels, traveling object 10 is used to carry the delivery between the two points instead of the delivery company. Thus, the delivery company can increase the delivery capacity while suppressing the number of delivery vehicles 20 they hold. Since the use of delivery vehicles 20 can be also suppressed, it is possible to reduce the working hours of the drivers of the delivery company. In this manner, efficiency in delivery tasks can be increased while suppressing capital investment.

### OTHER EMBODIMENTS

The information processing method and information processing system 100 according to one or more than one aspect of the present disclosure are described above on the basis of the embodiment. However, the present disclosure is not limited to the descriptions in the embodiment. One or more than one aspect of the present disclosure may include embodiments obtained by making various changes envisioned by those skilled in the art to the embodiments and embodiments obtained by combining structural elements described in different embodiments, on the condition that such embodiments do not depart from the scope of the present disclosure.

In the above embodiment, for instance, one of two points between which traveling object 10 regularly travels is within a predetermined distance from the location of the origin of a delivery, and the other is within a predetermined distance from the location of the destination of the delivery. However, the two points are not limited to such conditions. For instance, if other conditions, such as a delivery time, are met, one of the two points may not be within the predetermined distance from the location of the origin, or the other may not be within the predetermined distance from the location of the destination.

In the above embodiment, the following example is described with reference to FIG. 1: the delivery person of delivery vehicle 20b of base B2 collects the delivery from traveling object 10a at home P1 and delivers the delivery to home T1. However, instead of the delivery person of delivery vehicle 20b of base B2 near home P1, the delivery person of delivery vehicle 20 of another base that happens to travel near home P1 may collect the delivery from traveling object 10a at home P1 and deliver the delivery to home T1.

In the above embodiment, for instance, one of the two points between which traveling object 10 regularly travels is in an area covered by delivery services provided by a delivery base which is the origin, and the other is in an area covered by delivery services provided by another delivery base. However, the two points are not limited to such conditions. For instance, one of the two points may not be in the area covered by the delivery services provided by the delivery base which is the origin, or the other may not be in the area covered by the delivery services provided by another delivery base. In addition, the following example is described with reference to FIG. 1: the delivery person of delivery vehicle 20b of base B2 collects the delivery from traveling object 10a at home P1 and delivers the delivery to home T1. However, delivery vehicle 20b does not have to be used. Instead, the administrator of traveling object 10a may deliver the delivery to home T1, or the recipient of the delivery may go to home P1 of the administrator of traveling object 10a to receive the delivery.

In the above embodiment, for instance, detector 103 detects, from the travel history, a travel-start time slot or a travel-finish time slot of traveling object 10 at each of the two points. However, detector 103 does not have to detect the time slots. Accordingly, delivery information obtainment unit 105 does not have to obtain a delivery time at which the delivery is expected to arrive at the destination. In addition, creator 107 does not have to create a delivery route based on the time slots and the delivery time.

In the above embodiment, for instance, information processing system 100 includes calculator 104. However, information processing system 100 does not have to include calculator 104. That is, the degree of reliability for a travel regularity of traveling object 10 between the two points does not have to be calculated.

In the above embodiment, for instance, information processing system 100 includes querying unit 106. However, information processing system 100 does not have to include querying unit 106. That is, it is not necessary to query the administrator of traveling object 10 about the travel schedule of traveling object 10 during delivery of the delivery. Thus, creator 107 does not have to create a travel route based on a reply to the query.

In the above embodiment, for instance, information processing system 100 includes offering unit 109. However, information processing system 100 does not have to include offering unit 109. That is, after completion of delivery of the delivery based on the delivery route, a benefit does not have to be offered to the administrator of traveling object 10.

In the above embodiment, for instance, information processing system 100 includes notification unit 110. However, information processing system 100 does not have to include notification unit 110. That is, it is not necessary to notify the administrator of traveling object 10 that the delivery is to be or has been put in or collected from traveling object 10 at each of the two points.

In the above embodiment, for instance, information processing system 100 includes request unit 111. However, information processing system 100 does not have to include request unit 111. That is, it is not necessary to request traveling object 10 to unlock the trunk or a door of traveling object 10 at the two points.

The present disclosure can be embodied as a program that a processor will run to implement the steps included in the information processing method. Moreover, the present disclosure can be embodied as a non-transitory computer-readable recording medium, such as a CD-ROM, that stores the program.

If for instance the present disclosure is embodied as a program (software), the program is run using hardware resources, such as the CPU, memory, and input/output circuits of a computer, which enables the steps to be performed. That is, the CPU obtains data from the memory or input/output circuits, performs computations, and outputs the results of the computations to the memory or input/output circuits, which enables the steps to be performed.

It should be noted that in the above embodiment, each structural element of information processing system 100 may be dedicated hardware or be caused to function by running a software program suitable for the structural element. To cause each structural element to function, a program running unit, such as a CPU or a processor, may read and run the software program stored in a recording medium, such as a hard disk or semiconductor memory.

A part or all of the functions of information processing system 100 according to the embodiment are typically incorporated into an LSI, an integrated circuit. The elements of information processing system 100 may be made as individual chips, or a part or all of the elements may be incorporated into one chip. The type of circuit integration is not limited to an LSI, and a dedicated circuit or a general-purpose processor may be used. A field programmable gate array (FPGA) that can be programmed after an LSI is manufactured or a reconfigurable processor that can reconfigure the connections and settings of circuit cells inside an LSI may be used.

The present disclosure includes various variations obtained by making changes envisioned by those skilled in the art to the embodiments of the present disclosure, on the condition that such variations do not depart from the scope of the present disclosure.

### INDUSTRIAL APPLICABILITY

The information processing method and information processing system according to the present disclosure are applicable to, for example, a device that creates a delivery route of a delivery.

1. An information processing method implemented by a computer, the information processing method comprising:
obtaining a travel history of a traveling object;
detecting, from the travel history, two points between which the traveling object regularly travels;
obtaining a location of an origin of a delivery and a location of a destination of the delivery;
creating a delivery route of the delivery according to the location of the origin, the location of the destination, and the two points; and
outputting the delivery route.

2. The information processing method according to claim 1,
wherein the traveling object travels for a purpose other than to deliver the delivery.

3. The information processing method according to claim 1,
wherein one of the two points is within a predetermined distance from the location of the origin, and an other of the two points is within a predetermined distance from the location of the destination.

4. The information processing method according to claim 1,
wherein one of the two points is within an area covered by delivery services provided by a delivery base which is the origin, and an other of the two points is within an area covered by delivery services provided by another delivery base.

5. The information processing method according to claim 1,
wherein at each of the two points, the traveling object stays (a) longer than at any other point on a travel route including the two points or (b) for at least a predetermined period of time, the travel route being detected from the travel history and regularly traveled by the traveling object.

6. The information processing method according to claim 1,
wherein the two points are both endpoints of a travel route including the two points, the travel route being detected from the travel history and regularly traveled by the traveling object.

7. The information processing method according to claim 1, further comprising:
detecting, from the travel history, a travel-start time slot or a travel-finish time slot of the traveling object at each of the two points; and
obtaining a delivery time at which the delivery is expected to arrive at the destination,
wherein the creating of the delivery route includes creating the delivery route further according to the delivery time and the travel-start time slot or the travel-finish time slot of the traveling object at each of the two points.

8. The information processing method according to claim 1, further comprising:
calculating, according to the travel history, a degree of reliability for a travel regularity of the traveling object between the two points,
wherein the detecting of the two points includes detecting the two points further according to the degree of reliability.

9. The information processing method according to claim 1, further comprising:
querying an administrator of the traveling object about a travel schedule of the traveling object during delivery of the delivery,
wherein the creating of the delivery route includes creating the delivery route further according to a reply to the querying.

10. The information processing method according to claim 1, further comprising:
offering a benefit to an administrator of the traveling object after completion of delivery of the delivery based on the delivery route.

11. The information processing method according to claim 1, further comprising:
notifying an administrator of the traveling object that the delivery is to be or has been put in or collected from the traveling object at each of the two points.

12. The information processing method according to claim 1, further comprising:
requesting the traveling object to unlock a trunk or a door of the traveling object at the two points.

13. An information processing system, comprising:
a travel history obtainment unit that obtains a travel history of a traveling object;
a detector that detects, from the travel history, two points between which the traveling object regularly travels;
a delivery information obtainment unit that obtains a location of an origin of a delivery and a location of a destination of the delivery;
a creator that creates a delivery route of the delivery according to the location of the origin, the location of the destination, and the two points; and
an output unit that outputs the delivery route.
